(19) United States
(12) Patent Application Publication
(10) Pub. No.: US 2015/0069641 A1
(43) Pub. Date: Mar. 12, 2015

(54) CARBURETOR FOR AIR SCAVENGED ENGINE

(71) Applicant: WALBRO ENGINE MANAGEMENT, LLC., Tucson, AZ (US)

(72) Inventor: Scott D. Bostian, Kingston, MI (US)

(21) Appl. No.: 14/483,442

(22) Filed: Sep. 11, 2014

Related U.S. Application Data
(60) Provisional application No. 61/876,504, filed on Sep. 11, 2013.

(51) Int. Cl. F02M 9/00

(52) U.S. Cl. CPC F02M 9/00
USPC 261/64.1

(57) ABSTRACT

A fuel and air supply device for an engine includes at least one carburetor body having a main bore and an air passage and an air valve operably associated with the air passage to control air flow through the air passage. In at least some implementations, the air passage has a portion with a reduced dimension compared to a different portion of the passage. This may facilitate, among other things, a varying external size of the device and facilitate its use within constrained spaces.

### REFERENCE TO CO-PENDING APPLICATION

This application claims the benefit of U.S. Provisional Application No. 61/876,504 filed Sep. 11, 2013, which is incorporated herein by reference in its entirety.

### TECHNICAL FIELD

The present disclosure relates generally to a carburetor for an air scavenged engine.

### BACKGROUND

A carburetor is used to provide a combustible charge or mixture of fuel and air to an internal combustion engine. The carburetor meters liquid fuel for mixing with air to adjust a fuel-to-air ratio, according to varying engine requirements during engine startup, idle, steady-state operation, and changes in load and altitude.

A diaphragm-type carburetor is typically used with small two-stroke internal combustion engines commonly used in hand-held power tools such as chain saws, weed trimmers, leaf blowers, and the like. In the diaphragm carburetor, a body defines a mixing passage with an air inlet and a downstream fuel-and-air mixture outlet. A throttle valve is disposed in the fuel-and-air mixing passage downstream of the air inlet for controlling delivery of a primary fuel-and-air mixture to the engine.

A scavenging-type of diaphragm carburetor may be used with some engines to reduce scavenging losses or blow-through of some of the fuel-and-air mixture out of engine exhaust ports. A scavenging carburetor is known to have a fuel-and-air mixture passage and a separate scavenging air passage that both communicate at one end of the carburetor with a clean air source at atmospheric pressure, such as an air filter.

### SUMMARY

A fuel and air supply device for an engine includes at least one carburetor body having a main bore and an air passage and an air valve operably associated with the air passage to control air flow through the air passage. In at least some implementations, the air passage has a portion with a reduced dimension compared to a different portion of the passage. This may facilitate, among other things, a varying external size of the device and facilitate its use within constrained spaces.

A fuel and air supply device for an engine may include at least one carburetor body having a main bore and an air passage and an air valve. The air passage may have an inlet end through which air enters the air passage and an outlet end from which air exits the air passage. And in at least some implementations, the air valve is carried at least partially within the air passage to control air flow through the air passage. Also in at least some implementations, the air passage has a portion with a reduced dimension compared to a different portion of the passage. The air passage may also have a first air flow area that is defined in the area of the air valve and is determined by deducting the size of the obstruction caused by the air valve from the flow area of the air passage, and the minimum air flow area in the air passage downstream of the air valve is at least equal to the first air flow area. The air passage may further be noncircular downstream of the air valve to reduce the height of a portion of the air passage without reducing the air flow area of the air passage downstream of the air valve.

### BRIEF DESCRIPTION OF THE DRAWINGS

The following detailed description of preferred embodiments and best mode will be set forth with reference to the accompanying drawings, in which:

FIG. 1 is a cross-sectional view of a portion of a carburetor showing a main bore and an air passage;

FIG. 2 is a fragmentary end view of the carburetor showing an inlet side of the air passage; and

FIG. 3 is a fragmentary end view of the carburetor showing an outlet side of the air passage.

### DETAILED DESCRIPTION OF PREFERRED EMBODIMENTS

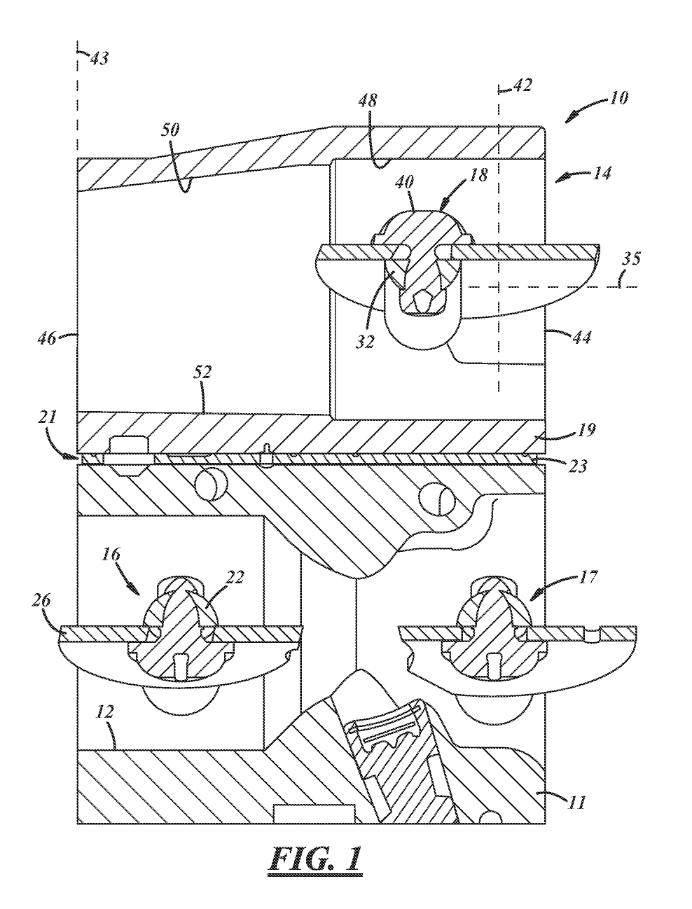

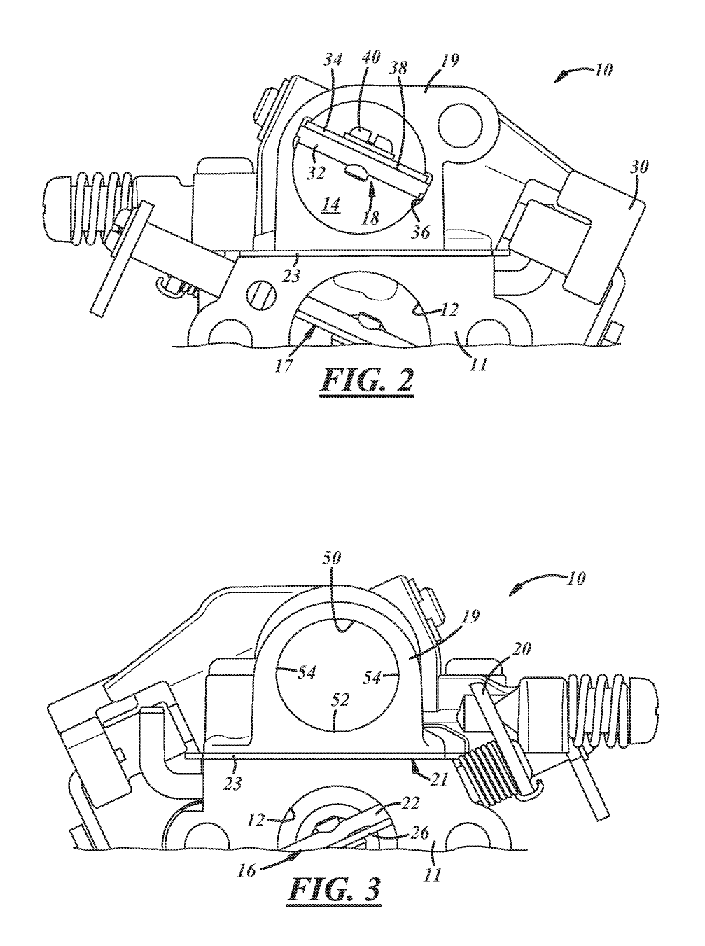

Referring in more detail to the drawings, FIGS. 1-3 show a carburetor 10 that may be used to supply a fuel and air mixture to an engine to support combustion in the engine. The carburetor 10 as shown is a diaphragm type carburetor having a main body 11 with a main bore 12 through which a fuel and air mixture is delivered to the engine and an air passage 14 through which air is supplied to the engine. In at least one implementation, the air supplied to the engine from the air passage 14 may be used to scavenge or help remove exhaust gasses from the engine. The flow of the fuel and air mixture through the main bore 12 may be controlled, at least in part, by a throttle valve 16 and optionally a choke valve 17. And the flow of air through the air passage 14 may be controlled, at least in part, by an air valve 18 operably associated with the air passage. This type of carburetor 10 may be referred to as a stratified scavenging carburetor, or an air scavenging carburetor. The carburetor 10 may be constructed and may operate as disclosed in U.S. Pat. No. 6,896,245 issued on May 24, 2005, the disclosure of which is incorporated herein by reference in its entirety.

In at least certain implementations, the main bore 12 may be formed in the main carburetor body 11. The air passage 14 may be formed in a separate scavenging air body 19 which may be formed separately from the main body 11 and attached thereto, such as by one or screws or in some other way. The air body 19 may also be formed from the same piece of material as the main body 11, if desired. When formed separately, a carburetor component, such as a fuel pump assembly 21, may be located between the main bore 12 and the air passage. In the embodiment shown in FIG. 1, the fuel pump assembly 21 includes a diaphragm and a sealing gasket (both denoted by reference number 23 in the figures) located between the main body 11 and the air body 19. The air valve 18 may be carried by the air body 19 and the throttle valve 16 may be carried by the main body 11.

As shown in FIG. 3, the throttle valve 16 may include an actuating lever 20 coupled to a throttle valve shaft 22 to rotate the throttle valve shaft 22, and a throttle valve head 26 may be carried on the valve shaft 22 and within the main bore 12. The throttle valve shaft 22 may be rotatably received in a bore that intersects the main bore 12. The throttle valve head 26, in the implementation shown, is a thin disc or butterfly-type valve head. The valve head 26 may be rotated from a first position closing or substantially closing the main bore 12 to a second position wherein the valve head 26 may be fully opened as shown in FIG. 1. In at least some implementations, the valve head 26 when in its second position may be parallel, or nearly parallel, to fluid flow through the main bore 12. The throttle valve 16 could be of a different type and construction, as desired. By way of one non-limiting example, the throttle valve 16 could be a rotary throttle valve such as is shown in U.S. Pat. No. 6,394,425 or a different type of valve.

In the implementation shown, the air valve 18 is constructed similarly to the throttle valve 16. In this way, the air valve 18 may have an actuating lever 30 coupled to an air valve shaft 32 to rotate the air valve shaft 32, and an air valve head 34 may be carried on the air valve shaft 32 and at least partially within the air passage 14. The air valve shaft 32 may be rotatably received in a bore 36 that intersects the air passage 14. The air valve shaft 32 may be oriented at the same angle as the throttle valve shaft 22, if desired, to facilitate coupling of the valves 16, 18 and actuation of the air valve 18 by the throttle valve 16. Due to the angle needed for the air valve shaft 32 in at least certain implementations, it may be desirable to offset the shaft 32 relative to the air passage 14 to provide clearance for one or more other carburetor components. In the example shown, the fuel pump is disposed between the main bore 12 and air passage 14 and the axis of the air valve shaft 32 is offset from a central axis 35 (shown in FIG. 1) of the air passage (here it is shown as being raised relative to a central axis) to provide clearance for the fuel pump.

The air valve head 34, in the implementation shown, is a thin disc or butterfly-type valve head. The air valve head 34 is connected to the shaft 32 in a position so that it may be rotated from a first position closing or substantially closing the air passage to a second position wherein the air valve head may be fully opened (in at least some implementations, the air valve head when in its second position may be parallel, or nearly parallel, to fluid flow through the air passage as generally shown in FIG. 1).

In more detail, and as shown in FIG. 1, the air valve shaft 32 may be generally cylindrical and include a flat section 38 extending in the area of the air passage 14. The air valve head 34 may be connected to the flat section 38 of the air valve shaft 32, such as by a screw 40, adhesive, weld or other connector or connection feature. The air valve head 34, in at least some implementations, may be sized to fully or at least substantially close the air passage 14. Accordingly, when the air valve 18 is in its first position, usually associated with idle engine operation, the air valve fully or substantially prevents air flow through the air passage 14. This substantially limits or prevents the flow of air through the air passage 14 and to the engine to avoid leaning out the fuel and air mixture delivered to the engine during certain engine operating conditions, such as engine starting or idle engine operation.

The air passage 14 has a portion with a reduced dimension compared to a different portion of the air passage 14. In at least some implementations, a portion of the air passage 14 has a first dimension in a first plane 42 perpendicular to the air flow direction in the air passage 14 and a different portion of the air passage has a smaller dimension taken in a second plane 43 spaced from and parallel to the first plane 42. The air passage 14 may have at least a portion with a noncircular shape in cross-section taken in a plane (e.g. second plane 43) perpendicular to the direction of air flow through the air passage.

In the nonlimiting implementation shown, the air passage 14 has an inlet end 44 through which air from a filter enters the air passage and an outlet end 46 from which air exits the air passage and is delivered to the engine. In this implementation, the air passage 14 is noncircular downstream of the air valve 18 to reduce the height of a portion of the air body 19 without reducing the air flow area of the air passage downstream of the air valve. In the example shown, the air passage 14 is oblong or generally oval in shape downstream of the air valve 18, and circular in the area of and upstream of the air valve. The circular inlet section 48 works well with a circular air valve head 34 which may be easier to manufacture at least when no or only very limited air flow is desired when the air valve is in its first, closed position. Downstream of the inlet section 48, the air passage 14 tapers down in height (e.g. dimension perpendicular to air flow in the air passage) and could optionally become wider in the dimension parallel to air flow although it need not become wider. Where the air passage 14 does not become wider along its length it may be possible to form the passage with a single core that is pulled from the carburetor from the inlet side during manufacturing of the air body 19.

In at least some implementations, the flow area in the air passage 14 downstream of the air valve 18 is the same as or increased relative to the flow area of the inlet section 48 so that the flow area of the air passage downstream of the air valve does not create any significant restriction or resistance to air flow compared to the inlet section 48. That is, the area of the air passage 14 including the air valve 18 provides the same or a greater restriction than the portion of the air passage downstream of the air valve. The portion of the air passage 14 downstream of the air valve 18 may have a lesser cross-sectional area (perpendicular to air flow) than the inlet section 48, in at least certain implementations. Of course, the air passage downstream of the air valve 18 may have a lesser flow area than the maximum flow area of the inlet section so that the downstream portion can cause a restriction to air flow therethrough, which may be desirable in certain applications.

In an engine that operates at or near WOT, the obstruction provided by the air valve 18, including the valve shaft 32, valve head 34, and any fastener 40 connecting the two, can be calculated as the surface area of those components perpendicular to the air flow through the air passage 14. The available flow area for air to pass through the air passage 14 and around the air valve 18 may be defined as a first flow area and may be determined as the difference between the total surface area of the air passage and the area of the obstructions in the air passage (e.g. the area of the air valve). The maximum flow area in the inlet section 48 occurs when there is a minimum restriction (e.g. minimum surface area obstruction) provided by the air valve 18. This may occur when the air valve 18 is fully opened and the valve head 34 is parallel (or nearly so) to the direction of air flow. Then, in designing the air passage 14, the portion downstream of the air valve 18 can be made to have a minimum flow area that is at least the same as the maximum flow area in the inlet section.

In at least some implementations, the height of the air passage 14 at its outlet end 46 may be up to about 85% less than the height at the inlet end 44. In one of many presently preferred embodiments, the height of the inlet end 44 of the air passage 14 is 16 mm and the height at the outlet end 46 of the air passage is 13.5 mm, with a generally smooth transition between the heights provided at least in part by a sloped or tapered upper wall 50 of the air passage, as shown in FIG. 1. The smooth transition may prevent undue disruption of the air flow. The lower wall 52 of the air passage 14, which is positioned adjacent to the main carburetor body 11, may be generally uniform in thickness. Although, in the implementation shown in FIGS. 1-3, there is an increasing thickness of the lower wall 52 providing a more gradual slope that also reduces the height of the air passage 14.

Hence, the reduction in height of the air passage 14 need not be uniform along the length of the air passage, need not be consistent along the length, and need not be the same between the upper and lower walls 50, 52 of the air passage. Likewise, the side walls 54 (FIG. 3), between and joining the upper and lower walls 50,52, need not flare outwardly at all, but if they do, they need not do so to the same extent or at the same rate so that opposite sides may take a different shape along at least a portion of the length of the air passage. With a round or generally round air passage 14, the side walls 54, and upper and lower walls 50, 52 will blend into one another and might not appear as discrete portions of the air passage. Regardless, in at least certain implementations, the air passage shape changes downstream of the inlet section to alter a dimension of the air passage as desired. The above descriptions have focused on reducing the height of the air passage 14, but the width could also be reduced, if desired. In at least some implementations, a dimension of the air passage 14 at the outlet 46 is less than the corresponding dimension of the air passage at the inlet 44. For example, in some carburetors a portion of the air passage 14 is circular in cross-section taken perpendicular to the direction of air flow through the air passage and a different portion of the air passage has a dimension that is less than the diameter of the circular portion. Further, where the air passage 14 is circular at the inlet 44, a portion of the outlet 46 of the air passage may have a dimension that is less than the diameter of the inlet 44.

Given that the walls defining the air passage 14 will have certain minimum thickness requirements, reducing the dimension of a part of the air passage will permit the air body 19 to have a reduced size at least in the area corresponding the reduced dimension portion of the air passage. Thus, changing the shape of the air passage 14 may permit the carburetor to fit into confined spaces on and relative to an engine. This provides greater design freedom and also permits different carburetors to be used on existing engines within existing space constraints. Where the air body 19 is separately formed from and later attached to the main carburetor body 11, as shown in the drawings, different air valve bodies may be mounted to the same main body 11 to permit that main body and its components (e.g. fuel metering assembly, fuel pump assembly, throttle valve, etc) to be used on different engines. When the minimum air flow area of the air passage 14 downstream of the air valve is at least as large as the maximum air flow area of the inlet section 48, then no significant reduction in air flow should occur due to the changed air passage shape downstream of the inlet section and the carburetor may readily be used on an engine without having to reconfigure or recalibrate other components or the engine.

While the change in shape of the air passage is shown and described as being gradual via tapered walls, the change in the air passage may be accomplished in other ways, including one or more discrete steps or by any other way (including going from a passage bounded by round or generally round walls to a polygon shaped passage, or the like). Also, the air valve shaft may be offset relative to the air passage and need not extend through the center of the passage or its widest portion. For example, the air valve shaft may be closer to one of the air passage upper and lower walls 50,52 than the other, as desired.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A fuel and air supply device for an engine, comprising:
at least one carburetor body having a main bore and an air passage;
an air valve operably associated with the air passage to control air flow through the air passage where the air passage has a portion with a reduced dimension compared to a different portion of the passage.

2. The device of claim 1 wherein the air valve is carried by the body within the air passage and the portion of the air passage with a reduced dimension is spaced from the air valve.

3. The device of claim 1 wherein a portion of the air passage is circular in cross-section taken perpendicular to the direction of air flow through the air passage and a different portion of the air passage has a dimension that is less than the diameter of the circular portion.

4. The device of claim 1 wherein a portion of the air passage has a first dimension in a first plane perpendicular to the air flow direction in the air passage and a different portion of the air passage has a smaller dimension taken in a second plane spaced from and parallel to said first plane.

5. The device of claim 1 wherein the air passage is formed in a different piece of material than the main bore.

6. The device of claim 1 wherein the air passage is formed in the same piece of material as the main bore.

7. The device of claim 1 wherein the air valve is carried at least partially within the air passage and a first air flow area of the air passage is defined in the area of the air valve and is determined by deducting the size of the obstruction caused by the air valve from the flow area of the air passage, and the minimum air flow area in the air passage downstream of the air valve is at least equal to the first air flow area.

8. The device of claim 7 wherein the first air flow area is defined by the air valve when it is fully opened and provides the least air flow restriction in the air passage.

9. The device of claim 1 wherein the air valve is carried at least partially within the air passage and a first air flow area of the air passage is defined in the area of the air valve and is determined by deducting the size of the obstruction caused by the air valve from the flow area of the air passage, and the minimum air flow area in the air passage downstream of the air valve is less than the first air flow area.

10. The device of claim 1 wherein the air passage has at least a portion with a noncircular shape in cross-section taken in a plane perpendicular to the direction of air flow through the air passage.

11. The device of claim 1 which also comprises a diaphragm fuel pump disposed between the main bore and the air passage and the axis of the air valve shaft 32 is offset from a central axis of the air passage.

12. The device of claim 1 wherein the air passage has an inlet end through which air enters the air passage and an outlet end from which air exits the air passage, and the air passage is noncircular downstream of the air valve to reduce the height of a portion of the air passage without reducing the air flow area of the air passage downstream of the air valve.

13. The device of claim 12 wherein downstream of the inlet end the air passage tapers down in the dimension perpendicular to air flow in the air passage and becomes wider in the dimension parallel to air flow.

14. The device of claim 12 wherein the height of the air passage at its outlet end may be up to 85% less than the height at the inlet end.

15. The device of claim 14 wherein the reduction in height of the air passage between the inlet end and outlet end is not be uniform along the length of the air passage.

16. A fuel and air supply device for an engine, comprising:
at least one carburetor body having a main bore and an air passage, the air passage has an inlet end through which air enters the air passage and an outlet end from which air exits the air passage;
an air valve carried at least partially within the air passage to control air flow through the air passage where the air passage has a portion with a reduced dimension compared to a different portion of the passage and the air passage has a first air flow area that is defined in the area of the air valve and is determined by deducting the size of the obstruction caused by the air valve from the flow area of the air passage, and the minimum air flow area in the air passage downstream of the air valve is at least equal to the first air flow area, and the air passage is noncircular downstream of the air valve to reduce the height of a portion of the air passage without reducing the air flow area of the air passage downstream of the air valve.
